(19) United States
(12) Patent Application Publication
(10) Pub. No.: US 2002/0190898 A1
(43) Pub. Date: Dec. 19, 2002

(54) Method and apparatus for creating and distributing satellite orbit and clock data

(75) Inventors: Charles Abraham, San Jose, CA (US); Frank van Diggelen, San Jose, CA (US)

Correspondence Address: Moser, Patterson & Sheridan, LLP, Attorneys at Law, Suite 100, 595 Shrewsbury Avenue, Shrewsbury, NJ, 07702, US

(73) Assignee: Global Locate Inc.

(21) Appl. No.: 10/081,164

(22) Filed: Feb. 22, 2002

Related U.S. Application Data
(60) Provisional application No. 60/298,287, filed on Jun. 14, 2001.

(51) Int. Cl. G01S 5/14

(52) U.S. Cl. 342/357.09

(57) ABSTRACT

A method and apparatus for creating and distributing satellite orbit and clock data to a remote receiver. Satellite orbit and clock data is received from a satellite control station. At least a portion of the satellite orbit and clock data is extracted from memory, projected into the future, and formatted into a format prescribed by a remote receiver. The formatted data is transmitted to the remote receiver via a distribution network.

### CROSS-REFERENCE TO RELATED APPLICATIONS

This application claims benefit of U.S. provisional patent application serial No. 60/298,287, filed Jun. 14, 2001, which is herein incorporated by reference.

### BACKGROUND OF THE INVENTION

1. Field of the Invention

The present invention generally relates to creating and distributing satellite orbit and clock data for earth orbiting satellites. More specifically, the invention relates to a method and apparatus for obtaining satellite orbit and clock data directly from a satellite control station, processing the data and then distributing the processed data through a network or communications link.

2. Description of the Related Art

A positioning receiver for the Global Positioning System (GPS) uses measurements from several satellites to compute a position. The process of acquiring the GPS radio signal is enhanced in speed and sensitivity if the GPS receiver has prior access to a model of the satellite orbit and clock. This model is broadcast by the GPS satellites and is known as an ephemeris or ephemeris data. Each satellite broadcasts its own ephemeris once every 30 seconds. Once the GPS radio signal has been acquired, the process of computing position requires the use of the ephemeris data or other data representative of the satellites' orbits and clocks.

The broadcast ephemeris data is encoded in a 900 bit message within the GPS satellite signal. It is transmitted at a rate of 50 bits per second, taking 18 seconds in all for a complete ephemeris transmission. The broadcast ephemeris data is typically valid for 2 to 4 hours into the future (from the time of broadcast). Before the end of the period of validity the GPS receiver must obtain a fresh broadcast ephemeris to continue operating correctly and produce an accurate position. It is always slow (no faster than 18 seconds), frequently difficult, and sometimes impossible (in environments with very low signal strengths), for a GPS receiver to download an ephemeris from a satellite. For these reasons, it has long been known that it is advantageous to send the ephemeris to a GPS receiver by some other means in lieu of awaiting the transmission from the satellite. U.S. Pat. No. 4,445,118, issued Apr. 24, 1984, describes a technique that collects ephemeris data at a GPS reference station, and transmits the ephemeris to a remote GPS receiver via a wireless transmission. This technique of providing the ephemeris, or equivalent data, to a GPS receiver has become known as “Assisted-GPS”. Since the source of ephemeris in Assisted-GPS is the satellite signal, the ephemeris data remains valid for only a few hours. As such, the remote GPS receiver must periodically connect to a source of ephemeris data whether that data is received directly from the satellite or from a wireless transmission. Without such a periodic update, the remote GPS receiver will not accurately determine position.

The deficiency of the current art is that the ephemeris data must be received from the satellites before being retransmitted to the GPS receiver; this ephemeris data rapidly becomes invalid; and mobile devices may be out of contact from the source of the Assisted-GPS data when their current ephemeris becomes invalid.

Therefore, there is a need in the art for a method and apparatus for providing satellite orbit and clock data that is not received from the satellites and is valid for an extended period into the future, e.g., many days into the future.

### SUMMARY OF THE INVENTION

The present invention is a method and apparatus for obtaining satellite orbit and clock data directly from a satellite control station, and distributing this data through a network or communications link. The invention also includes a method for generating long term orbit and clock data, if this is not directly available from the satellite control station, and then distributing this long-term orbit and clock data.

By using the long-term orbit and clock data, a remote receiver may accurately operate for days without receiving an update of the broadcast ephemeris data as normally provided from the satellites.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system for collecting and distributing satellite orbit and clock data (SOCD) to remote GPS receivers;

FIG. 2 depicts a method for packing the SOCD into a format required by the remote GPS receivers;

FIG. 3 depicts a timeline showing many blocks of ephemeris data;

FIG. 4 depicts a method for forming a model of satellite orbit and clock trajectories;

FIG. 5 depicts an extract of a table containing trajectory values of satellite orbit and clock;

FIG. 6 depicts a method for projecting the SOCD into the future, and then packing the projected data in a format required by the remote GPS receivers;

FIG. 7 depicts a timeline of non-overlapping orbit and clock models that conform to the broadcast ephemeris format models as described in ICD-GPS-200C yet span many hours.

### DETAILED DESCRIPTION OF THE PREFERRED EMBODIMENT

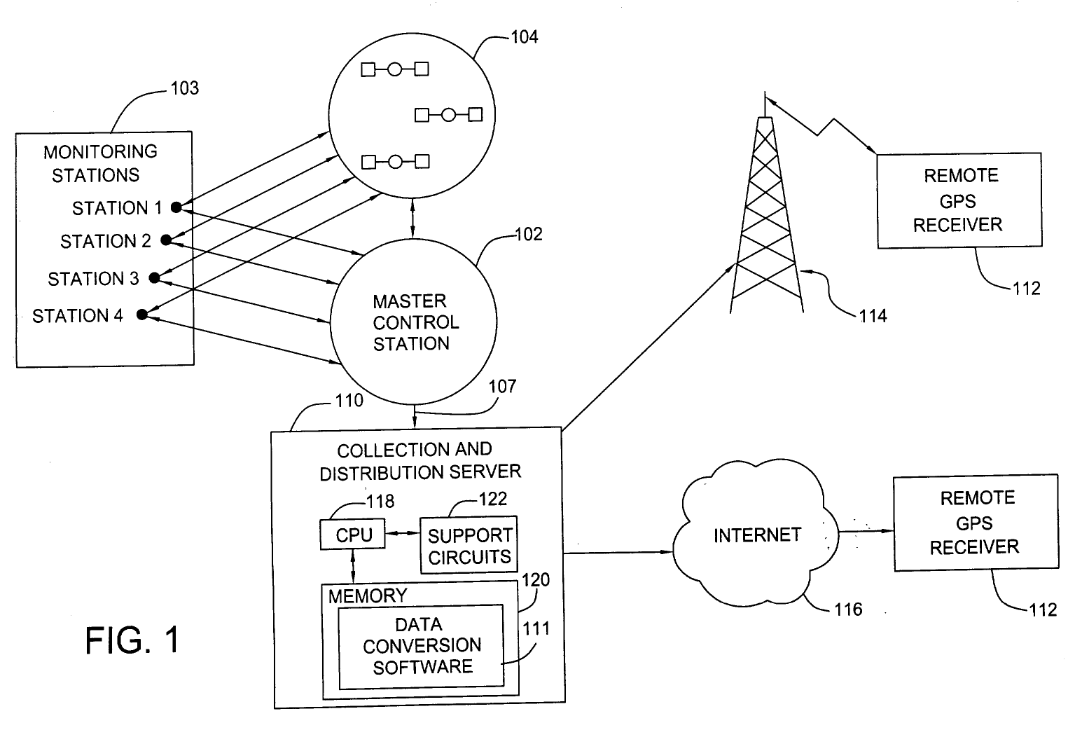

FIG. 1 depicts a block diagram of a system 100 for collecting and distributing satellite orbit and clock data (SOCD) (sometimes referred to herein as satellite tracking data). The following disclosure uses GPS as an illustrative system within which the invention operates. From the following disclosure, those skilled in the art will be able to practice the invention in conjunction with other satellite systems such as the Galileo satellite system.

Satellite orbit and clock data (SOCD) for the GPS constellation is maintained at the Master Control Station (MCS) 102, which is located at Falcon Air Force Base, Colorado Springs, Colo. The MCS 102 communicates the SOCD to GPS satellites 104 either directly, or via four satellite monitoring stations 103, which are located in Hawaii, Kwajalein, Ascension Island, and Diego Garcia, respectively. Without the current invention, the only way to get this data to a GPS receiver is first to wait for a satellite to broadcast at least a portion of the data. In the present embodiment, the MCS 102 also communicates the SOCD to a collection and distribution server 110 via a communication link 107. Communication link 107 comprises a frame relay or like type communication network. It is understood by those skilled in the art that the MCS 102 for the GPS system is illustrative of a particular satellite control station, and that the present invention is useful for operation with satellite control stations for other satellite systems in general.

The server 110 comprises a central processing unit (CPU) 118, support circuits 122, and memory 120. The CPU 118 may be any one of the many CPU's available on the market to perform general computing. Alternatively, the CPU may be a specific purpose processor such as an application specific integrated circuit (ASIC) that is designed to process satellite tracking information. The support circuits 122 are well known circuits such as clock circuits, cache, power supplies and the like. The memory 120 may be read only memory, random access memory, disk drive storage, removable storage or any combination thereof. The memory 120 stores executable software, e.g., data conversion software 111, that, when executed by the CPU 118, causes the system 100 to operate in accordance with the present invention.

The collection and distribution server 110 formats the data using the data conversion software 111 according to the relevant interface standard, and distributes the formatted data to GPS devices 112 that require satellite orbit and/or clock data. The distribution process may be by some form of wireless communications system 114, or over the Internet 116, or a combination of both, or by some other means of communication. Although, in most embodiments, the system distributes both orbit and clock data, the system may only receive and transmit orbit or clock data in certain applications of the system.

Once the GPS devices 112 have received sufficient orbit and/or clock data, they may operate continually for many days without needing to download fresh broadcast ephemeris from the satellites or from any other source. The orbit and clock data distributed to the GPS devices may be in the same format as the broadcast ephemeris or may be some other model format that is defined by the GPS device or that is defined by an industry standard within which the GPS device operates. Herein this reformatted orbit and clock data is generally referred to as a satellite tracking model (STM). The loading of the STM into the GPS receiver can be accomplished in many ways. Using the cradle for a personal digital assistant (PDA), direct connection to a network, or a wireless technology, such as Bluetooth or a cellular network, are a few examples of how the STM can be transferred to the receiver. The transmission is generally accomplished by broadcasting the STM without knowledge of the specific location of the GPS receiver. As such, the distribution server does not require the GPS receiver to send any information through the network to the distribution server.

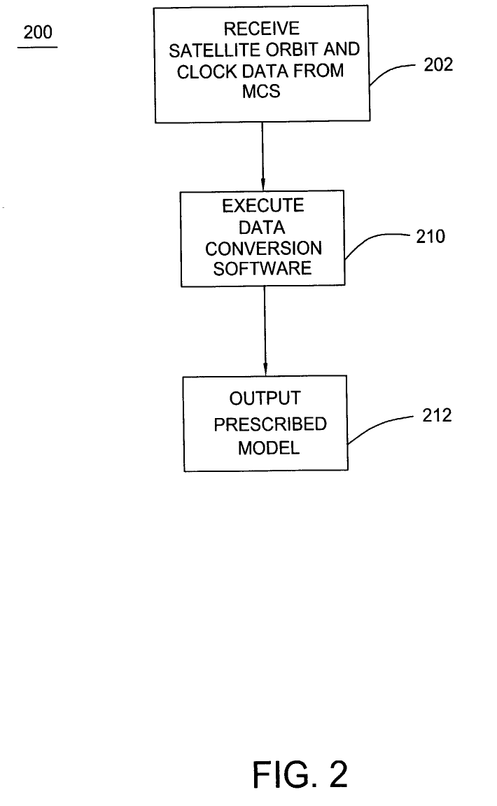

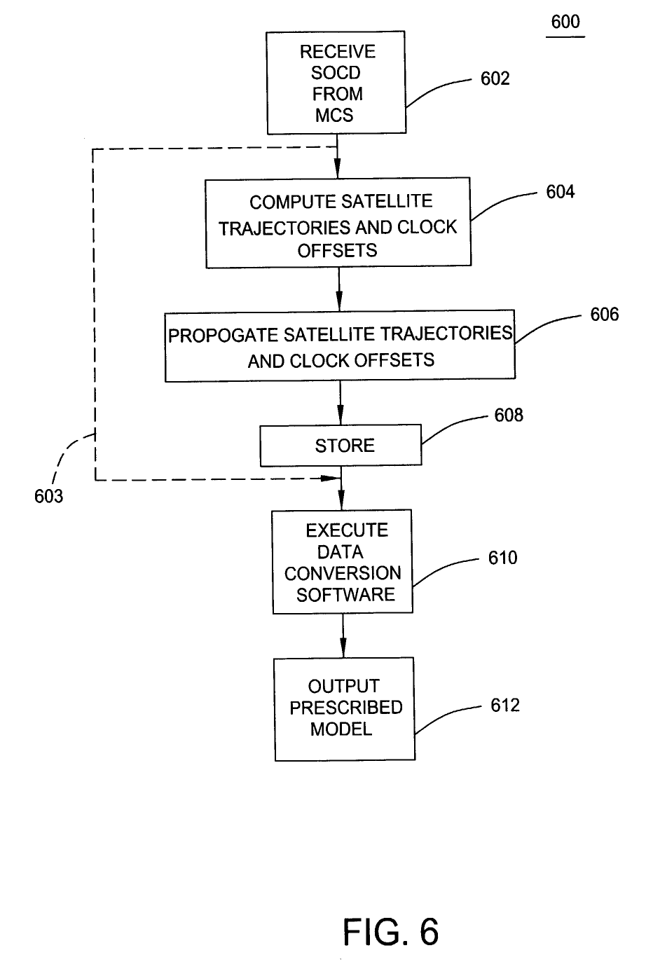

FIG. 2 illustrates the preferred embodiment of a process for packing the SOCD into a required format for use by a GPS receiver. The process begins at step 202 with the collection of satellite orbit and clock data from the satellite control center. In one embodiment, this data represents the future satellite orbits and clock values for many days into the future—this restriction is removed later, see FIG. 6 and the description accompanying it. At step 210 the data conversion software 111 is executed to cast the data into the form of a model required by the GPS receiver, or by the standards within which the receiver operates. At step 212, the prescribed model is output. The function of the data conversion software is described below.

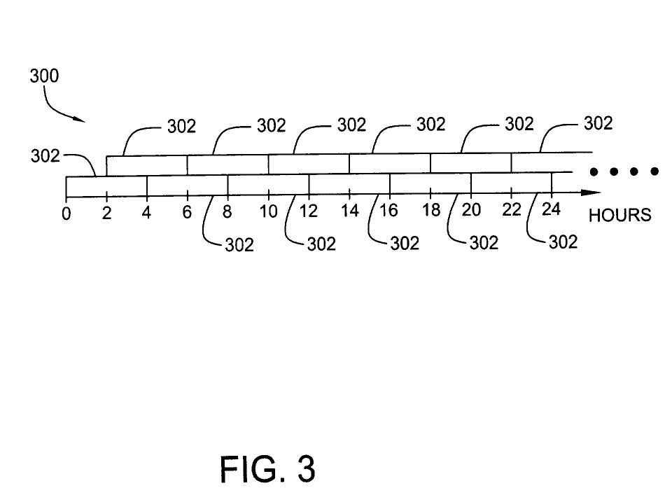

The data received from the satellite control center may be in the format of the ephemeris data specified in ICD-GPS-200c. A typical format is one in which a block of ephemeris data represents the future orbit and clock data of the satellite for a four hour window, this is illustrated in FIG. 3. Many overlapping blocks of ephemeris data are maintained at the satellite control center, so that the complete set of these 4-hour blocks of data represent the future orbit and clock data for the satellites for several days into the future. In one embodiment of the current invention, this complete set of blocks of data is sent to the remote GPS receiver; in this case the data conversion software 111 performs no conversion at all, simply passing the data through for distribution to remote GPS receivers. Note that, although there is no data conversion, this is nonetheless different from the way in which the GPS satellites broadcast the data. The satellites only broadcast a single block of ephemeris data that is typically valid for no more than 4 hours into the future, whereas the current invention distributes all the available blocks of ephemeris data, thus providing valid data for many days into the future.

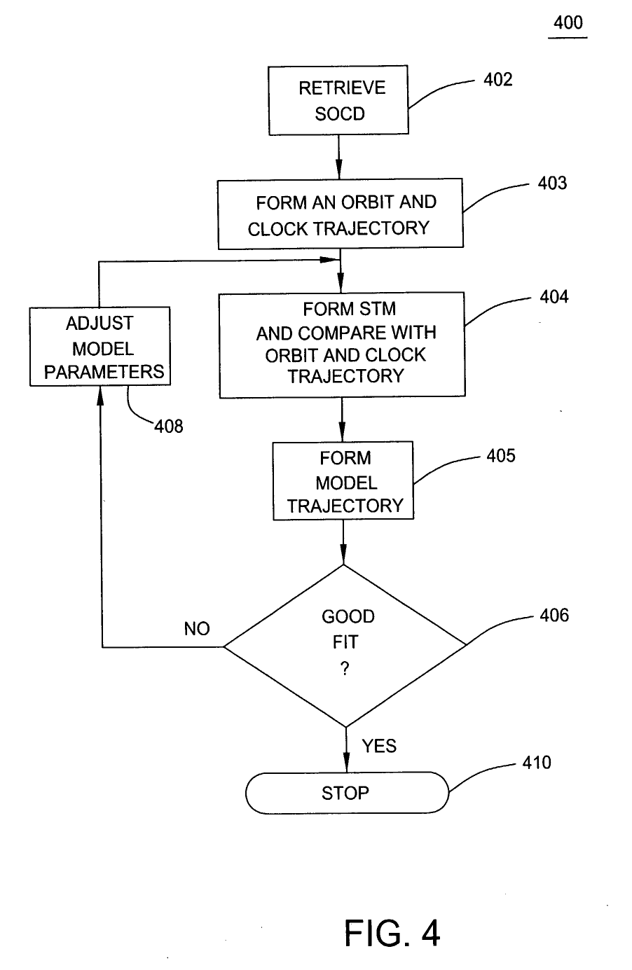

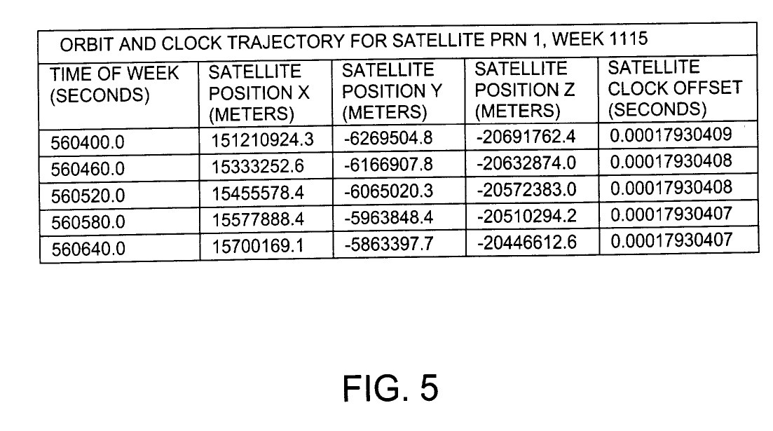

Alternative embodiments of the invention use data conversion software 111 that recasts the data into different forms. A block of ephemeris data is a model of the satellite's orbit and clock values for the period of time in which the data is valid. Alternative models of satellite orbit and clock values may be created, by beginning with a sequence 300 of blocks 302 of ephemeris data, such as in FIG. 3, and processing the data using a method 400 depicted in FIG. 4. At step 402, the SOCD is retrieved from the satellite control center. At step 403, an orbit and clock trajectory is formed of the satellite orbit. This trajectory covers the entire period of time covered by the complete set of blocks of data obtained from satellite control center. Similarly a trajectory is formed of the clock data. The form of these trajectory data may be a table, a small portion of which is shown in FIG. 5. At step 404, a Satellite Tracking Model (STM) is formed. At step 405, a Model Trajectory is formed, this is the trajectory that the STM model predicts, and may have the same form as the trajectory data table of FIG. 5, but may have different values for the satellite positions and clock offsets, depending on the quality of the model created in step 405. At step 406, the fit between the model trajectory and the original trajectory is evaluated. At step 408, the model is adjusted to improve the fit between the model trajectory and the original trajectory. The process is repeated until a good fit is obtained at step 406. The process ends at step 410.

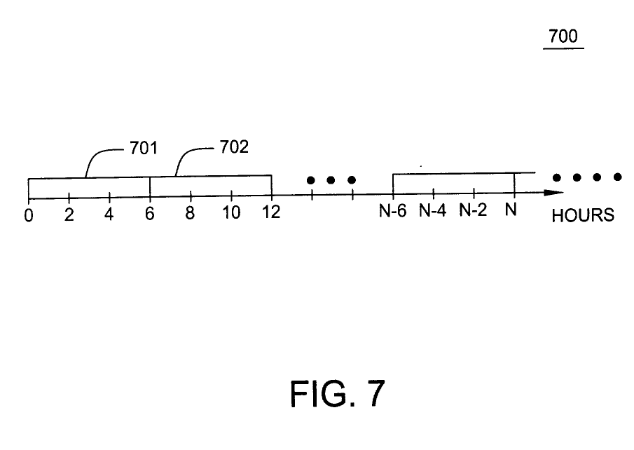

In one embodiment of the invention, the overlapping blocks of 4-hour ephemeris data are formed into a trajectory, which in turn is formed into a model of non-overlapping blocks, each covering a 6-hour window, as illustrated in FIG. 7.

Alternative embodiments may use longer fit intervals, such as 8, 14, 26, 50, 74, 98, 122, or 146 hours for each ephemeris model. Under the current invention, orbit and clock models with these fit intervals are generated from the overlapping blocks of data obtained from the satellite control station.

In the above description, it has been assumed that the satellite orbit and clock data, from the satellite control center, has been received in the form of overlapping blocks of ephemeris data, covering a period of several days into the future. This is merely one embodiment of the invention. Alternative embodiments of the SOCD may include observed satellite velocity, acceleration, clock drift, or clock drift rate and these terms may be used in the process of forming a table similar to FIG. 5 and fitting a model in a similar way to that described in FIG. 4.

In one such alternative embodiment, the data from the satellite control center may not extend as far into the future as desired. In this case, the process shown in FIG. 2 is replaced by the process shown in FIG. 6. At step 602, the method 600 receives the satellite data from the satellite control center. From this data, at step 604, the satellite trajectories and clock offsets are computed. The satellite orbit trajectories and clock offsets from step 604 are propagated into the future, using standard orbit models, such as gravity, drag, solar radiation pressure, tides, third body effects, precession, nutation, and other conservative and non-conservative forces affecting the satellite trajectory; as is well known in the art. This combination of known and estimated force models parameters is used in the propagation 606 to provide the propagated orbit for time outside the data fit interval. The clock offsets for GPS satellites are typically very small, and change linearly over time. These clock offsets are propagated into the future using standard models, such as a second order model containing clock offset, drift, and drift rate. Once the table of orbit and clock trajectory has been formed, the process proceeds at step 610 in the same way as previously described, to produce the required Satellite Tracking Model.

Another embodiment of a Satellite Tracking Model uses the spare data bits in the current ephemeris format of a conventional GPS signal to provide additional model parameters that would improve the data fit over long time intervals. For example, subframe 1 of the ICD-GPS-200c ephemeris model has 87 spare bits that are available for additional parameters. This technique allows for more parameters to describe the orbital motion of the satellites without compromising the standard data format. This new ephemeris model is based on the current ephemeris model with additional correction terms used to augment the model to support the longer fit intervals with greater accuracy.

Yet another embodiment of a model is to develop a new set of orbital parameters, that describe the satellite orbit and clock, which are different, in part or in their entirety, from the GPS ephemeris model parameters. With the goal of making the fit interval longer, different parameters may provide a better description of the satellite orbit. This new set of parameters could be defined such that they would fit into the existing data structures, however, their implementation and algorithms for use would be different.

Still a further embodiment of an orbit model would be to develop a new set of orbital parameters that would not fit into the existing GPS ephemeris model format. This new set of parameters would be developed to better address the trade-off between the number of parameters required, the fit interval, and the orbit accuracy resulting from the model. An example of this type of ephemeris parameter set is Brouwer's theory that could be used as-is or modified to account for GPS specific terms. Brouwer's theory as described in Brouwer, D. “Solution of the Problem of Artificial Satellite Theory without Drag”, Astron J. 64: 378-397, November 1959 is limited to satellites in nearly circular orbits such as GPS satellites.

Another embodiment is to use a subset of the standard ephemeris parameters defined in ICD-GPS-200c. This approach is particularly useful when bandwidth and/or packet size is limited in the communication link that will be used to convey the orbit model to the Remote GPS Receiver. In one such embodiment, the fifteen orbit parameters described above, and in ICD-GPS-200c, may be reduced by setting all harmonic terms in the model to zero, and leaving the following 9 parameters:

Square root of semi-major axis (metersˆ 1/2)

Eccentricity (dimensionless)

Mean motion difference from computed value (radians/sec)

Mean anomaly at reference time (radians)

Longitude of ascending node of orbit plane at weekly epoch (radians)

Inclination angle at reference time (radians)

Rate of inclination angle (radians/sec)

Argument of perigee (radians)

Rate of right ascension (radians/sec)

Process 400 of FIG. 4 is then executed using this subset of parameters. This reduces the amount of data that must be sent to the Remote GPS Receiver. The receiver can then reconstruct a standard ephemeris model by setting the “missing” harmonic terms to zero. There is a large number of alternative embodiments to reduce the size of the data, while still providing a model that fits the orbit and clock trajectory, including:

Removing parameters from the model, and replacing them with a constant, such as zero—as done above—or some other predetermined value, which is either stored in the Remote GPS Receiver, or occasionally sent to the receiver.

The resolution of the parameters may be restricted in the process 400, this too reduces the amount of data that must be sent to the mobile GPS receiver.

Parameters, which are similar among two or more satellites, may be represented as a master value plus a delta, where the delta requires fewer bits to encode; an example of this is the parameter Eccentricity, which changes very little among different GPS satellites.

Some of these approaches reduce the ability of the model to fit the data over a period of time (e.g., six hours). In this case, the fit interval may be reduced (e.g. to four hours) to compensate.

While the foregoing is directed to the preferred embodiment of the present invention, other and further embodiments of the invention may be devised without departing from the basic scope thereof, and the scope thereof is determined by the claims that follow.

1. A method for distributing satellite tracking data to a remote receiver comprising:
receiving satellite tracking data from a satellite control station;
representing at least a portion of said satellite tracking data in a format supported by the remote receiver; and
transmitting the formatted data to the remote receiver.

2. The method of claim 1 where the satellite tracking data comprises data representative of the satellite orbits.

3. The method of claim 1 where the satellite tracking data comprises data representative of future satellite orbits.

4. The method of claim 2, where the satellite tracking data further comprises data representative of the satellite clock offsets.

5. The method of claim 3a where the satellite tracking data further comprises data representative of the future satellite clock offsets.

6. The method of claim 1 wherein said satellite control station is the Master Control Station for at least one of a GPS satellite system or a Galileo satellite system.

7. The method of claim 6 wherein said receiving step comprises receiving said satellite tracking data from said Master Control Station via a frame relay communication link.

8. The method of claim 6 wherein said satellite tracking data comprises ephemeris data from at least one said GPS satellite system or said Galileo satellite system.

9. The method of claim 8 wherein said ephemeris data includes blocks of ephemeris data valid for a period of time in the future.

10. The method of claim 1 wherein said satellite tracking data comprises at least one of: a plurality of satellite positions with respect to time for a period of time into the future, a plurality of satellite clock offsets with respect to time for a period of time into the future.

11. The method of claim 1 wherein said satellite tracking data comprises at least one of: data representative of satellite positions, velocities or acceleration; data representative of satellite clock offsets, drift, or drift rates.

12. The method of claim 1 wherein said format comprises a format that is prescribed by said remote receiver.

13. The method of claim 1 wherein said format is a model containing at least one of: orbital parameters and clock parameters.

14. The method of claim 13 wherein said orbital parameters and clock parameters are defined by a global positioning system standard.

15. The method of claim 13 wherein said model comprises more than one sequential model, each sequential model being valid for a period of time.

16. The method of claim 13 wherein said model is valid for a period of four hours.

17. The method of claim 13 wherein said model is valid for a period of more than four hours.

18. The method of claim 1 wherein said remote receiver is a GPS receiver.

19. The method of claim 1 wherein said remote receiver is a satellite positioning system receiver.

20. The method of claim 1 wherein said format is a standard format for transmitting satellite models to a global positioning system receiver.

21. The method of claim 1 wherein the satellite tracking data is valid for a first period of time and the at least a portion of said satellite tracking data is valid for a second period of time, where said first period is longer than said second period.

22. The method of claim 1 wherein said transmitting step further comprises:
transmitting using a wireless communications link.

23. The method of claim 22 wherein said transmitting step further comprises:
broadcasting the formatted data to a remote receiver.

24. The method of claim 1 wherein said transmitting step comprises:
transmitting using a computer network.

25. The method of claim 24 wherein said transmitting step further comprises:
broadcasting the formatted data to a remote receiver.

26. The method of claim 1 wherein said transmitting step comprises:
transmitting using the Internet.

27. The method of claim 26 wherein said transmitting step further comprises:
broadcasting the formatted data to a remote receiver.

28. The method of claim 26 wherein said transmitting step couples the formatted data to the remote receiver when said remote receiver connects to the Internet.

29. The method of claim 26 wherein said transmitting step further comprises:
determining a time when a cost of transmitting the formatted data is relatively low; and
transmitting the formatted data at said time.

30. The method of claim 1, wherein said transmitting step further comprises:
determining a time when the congestion of a transmission network is relatively low;
transmitting the formatted data at said time.

31. Apparatus for distributing satellite tracking data to a remote receiver comprising:
a computer for receiving satellite tracking data from a satellite control station, accessing at least a portion of said satellite tracking data from a memory, and formatting at least a portion of said satellite tracking data in a format supported by the remote receiver; and
means for transmitting the formatted data to the remote receiver.

32. The apparatus of claim 31 wherein said satellite control station is the Master Control Station of at least one of a GPS satellite system or Galileo satellite system.

33. The apparatus of claim 32 further comprising a frame relay for communicating said satellite tracking data from said Master Control Station to said computer.

34. The apparatus of claim 32 wherein said satellite tracking data is ephemeris data of at least one of said GPS satellite system or Galileo satellite system.

35. The apparatus of claim 31 wherein said satellite tracking data comprises at least one of: a plurality of satellite positions with respect to time for a period of time into the future, a plurality of satellite clock offsets with respect to time for a period of time into the future.

36. The apparatus of claim 31 wherein said satellite tracking data comprises at least one of: data representative of satellite positions, velocities or acceleration; data representative of satellite clock offsets, drift, or drift rates.

37. The apparatus of claim 31 wherein said format comprises a format that is prescribed by said remote receiver.

38. The apparatus of claim 31 wherein said format is a model containing at least one of: orbital parameters and clock parameters.

39. The apparatus of claim 38 wherein said orbital parameters and clock parameters are defined by the global positioning system standard.

40. The apparatus of claim 38 wherein said model comprises more than one sequential model, each sequential model being valid for a period of time.

41. The apparatus of claim 38 wherein said model is valid for a period of more than four hours.

42. The apparatus of claim 31 wherein said remote receiver is a GPS receiver.

43. The apparatus of claim 31 wherein said remote receiver is a satellite positioning system receiver.

44. The apparatus of claim 31 wherein said format is a standard format for transmitting satellite models to a global positioning system receiver.

45. The apparatus of claim 31 wherein the satellite tracking data is valid for a first period of time and the at least a portion of said satellite tracking data is valid for a second period of time, where said first period is longer than said second period.

46. The apparatus of claim 31 wherein said transmitting means comprises:
a wireless communications link.

47. The apparatus of claim 31 wherein said transmitting means comprises:
a computer network.

48. The apparatus of claim 31 wherein said transmitting means comprises:
the Internet.
